(19) United States
(12) Patent Application Publication
(10) Pub. No.: US 2005/0048176 A1
(43) Pub. Date: Mar. 3, 2005

(54) Method and system for extending the shelf life of feed

(76) Inventors: Larry C. McNeff, Anoka, MN (US); Clayton V. McNeff, Anoka, MN (US); Peter G. Greuel, Anoka, MN (US)

Correspondence Address: Merchant & Gould P.C., P.O. Box 2903, Minneapolis, MN, 55402-0903, US

(21) Appl. No.: 10/650,496

(22) Filed: Aug. 28, 2003

(51) Int. Cl. A23K 1/00

(52) U.S. Cl. 426/335

(57) ABSTRACT

A feed composition comprising hydrogen peroxide that resists mold and yeast growth is disclosed along with methods for applying the hydrogen peroxide to the feed composition. In one embodiment the major ingredient of the feed composition is a distillers' grain, which is combined with hydrogen peroxide to prevent mold and yeast growth and extend the life of the feed product.

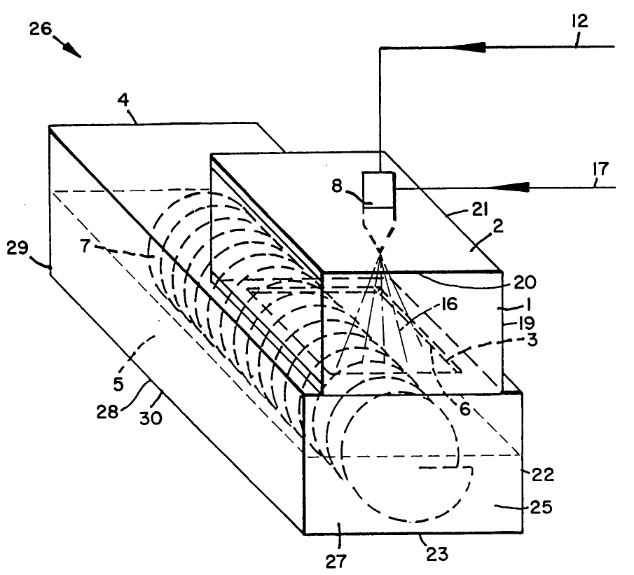

### FIELD OF THE INVENTION

This invention relates generally to the field of livestock feed and more particularly to methods for extending the shelf life of livestock feed.

### BACKGROUND OF THE INVENTION

Distillers' grain (“DG”) is a co-product produced when cereal grains are used in the production of fuel or beverage ethanol. An example of a process that produces distillers' grain as a co-product is disclosed in U.S. Pat. No. 5,439,701 filed Apr. 15, 2001, which is hereby incorporated by reference in its entirety.

The amount of DG being produced is increasing both because the number of fuel ethanol production facilities is increasing, and also because production has increased in existing facilities. Distillers' grain is comprised primarily of protein, fat (oil), fiber, minerals and water, which make it a good feed source for dairy and beef cattle, swine and poultry.

There are many factors that contribute to the quality of the DG including initial grain quality and the processing conditions. The DG typically leaves the ethanol production process in a sterile condition because of the high temperatures associated with ethanol production. Thus, mold and yeast contaminate the DG post-production, which may occurred in transportation, passing through contaminated feed-handling equipment, such as augers, elevators, drag lines, bagging equipment and trucks. In storage, feed can become contaminated by storage bins or by contact with dust, insects, rodent, birds and other animals.

Furthermore, DG can be high in moisture content. This moisture combined with DG's composition, namely protein, fat and fiber, provide a favorable environment for mold and yeast growth. Thus, mold and yeast growth typically reduce the untreated DG's shelf life to approximately three days. This creates logistical problems for the ethanol facilities producing the DG and the livestock facilities that feed it. Without extending DG's shelf life, the ethanol facilities producing it are limited to how long they can store the product and to how far they can ship it. Livestock facilities are also limited to how long they can store the DG before mold and yeast growth prevent its use.

In some cases, the DG is dried to reduce its moisture content. Drying the DG may inhibit the growth of mold and yeast depending on how much moisture is removed, but drying the DG can be expensive and not always desired. Furthermore, moisture may be reintroduced to the DG during shipping or storage, which would promote the growth of mold and yeast.

Because DG is contaminated after production, heating, irradiation and other sterilization techniques may not be as effective at increasing the shelf life of DG as the addition of chemical preservatives, which continue to work through the life of the product. Thus, chemical preservatives, which remain with the DG, work better to extend the shelf life of the feed. There are numerous materials that are known to function as chemical preservatives in livestock feed, including, for example: ascorbic acid, ascorbyl palmitate, benzoic acid, butylated hydroxylanisole, butylated hydroxytoluene, calcium ascorbate, calcium propionate, calcium sorbate, citric acid, dilauryl thiodipropionate, distearyl thiodipropionate, erythrobic acid, ethoxyquin, formic acid, methylparaben, potassium bisulfate, potassium metabisulfate, potassium sorbate, propionic acid, proply gallate, propylparaben, guaiac gum, sodium ascorbate, sodium benzoate, sodium bisulfate, sodium metabisulfate, sodium nitrite, sodium propionate, sodium sorbate, sodium sulfite, sorbic acid, stannous chloride, sulfur dioxide, tertiary butyl hydroquinone, thiodipropionic acid and tocopherols.

### SUMMARY OF THE INVENTION

The present disclosure relates to a feed containing hydrogen peroxide that inhibits mold and yeast growth. This disclosure also relates to a method for applying hydrogen peroxide to the feed.

In one embodiment, distillers' grain is combined with hydrogen peroxide to inhibit mold and yeast growth and to extend the shelf life of the feed. Feed as used herein means any feed, major or minor ingredient or any component thereof. Another embodiment of the present disclosure relates to a method for applying hydrogen peroxide onto a feed to extend the shelf life of the feed. In this embodiment, the feed stream enters a mix housing, which defines a mix chamber and is moved through the mix chamber by an actuating device contained therein. Adjacent to the mix housing is a spray housing, which defines a spray chamber. The feed stream passes through a volume created by a portion of the mix chamber that is in fluid communication with the spray chamber. At least one nozzle is coupled to the spray housing and connected to an aqueous solution of hydrogen peroxide and, in some cases, to an air line. The nozzle creates a fog of the aqueous solution of hydrogen peroxide in the spray chamber and in a volume of the mix chamber adjacent to the spray chamber. The fog of hydrogen peroxide is deposited on the feed stream. As the feed stream continues through the mix chamber, the actuating device mixes the hydrogen peroxide and the feed stream.

### BRIEF DESCRIPTION OF THE DRAWING

The drawing is a diagram of a system for applying the hydrogen peroxide according to the principles of the present disclosure.

### DETAILED DESCRIPTION OF THE PREFERRED EMBODIMENT

The inventors have found a novel way to extend the shelf life of feed products, such as those containing DG, by using hydrogen peroxide to prevent the growth of mold and yeast. Typically, visual detection of mold and yeast does not occur for 36 hours in feed containing ingredients, such as, DG. This may vary, however, depending the feeds content and environment. Tests show that adding hydrogen peroxide to DG inhibits the growth of mold and yeast. For example, in a control sample, with a mass of approximately 72 grams of DG, mold and yeast were visually detected after about 3 days. When the DG was mixed with an aqueous solution of hydrogen peroxide such that the mixture contained 2.0% by weight hydrogen peroxide mold and yeast were not visually present for 174 hours or about 7 days. When the DG was mixed with an aqueous solution of hydrogen peroxide such that the mixture contained 4.1% by weight hydrogen peroxide mold and yeast were not visually present for 310 hours or about 13 days. When the DG was mixed with an aqueous solution of hydrogen peroxide such that the mixture contained 6.1% by weight hydrogen peroxide mold and yeast were not visually present for 406 hours or about 17 days. When the DG was mixed with an aqueous solution of hydrogen peroxide such that the mixture contained 6.4% by weight hydrogen peroxide mold and yeast were not visually detected after 30 days, at which point the experiment was terminated. These weight percentages of hydrogen peroxide are by way of example only. The amount of hydrogen peroxide could be any amount sufficient to inhibit the growth of mold and yeast on a feed product.

The test did show some variability in the performance of the hydrogen peroxide in reducing mold and yeast growth, such variability is likely due to varying conditions of the DG used. For example, some of the samples may have had more or less contamination from outside sources prior to the experiment, which would cause variability in the performance of the hydrogen peroxide.

There are many ways in which the hydrogen peroxide can be added to the feed to obtain the desired weight percent of hydrogen peroxide to total mass of the feed. The drawing shows a system 26 that illustrates just one example system used in connection with the present disclosure to combine the feed and the hydrogen peroxide. In that example system, the feed 25 is passed through a mix housing 4 and under a spray chamber 2 such that an aqueous solution of hydrogen peroxide 16 is sprayed onto the passing feed stream 25, or the hydrogen peroxide solution 16 is mixed with air and the mixture of air and hydrogen peroxide 16 is sprayed onto the passing feed stream.

In this example embodiment, the mix housing 4 defines a mix chamber 5 and a mix chamber opening 6. The mix housing 4 is used to transport material from one point in a feed processing plant to another point in the feed processing plant. Inside the mix chamber 5 is an actuating device 7. While inside the mix housing 4, feed stream 25 is progressed through the mix chamber 5 and mixed by the actuating device 7. The actuating device 7 can be anything capable of moving and mixing the feed stream 25 through the mix chamber 5.

The mix housing 4 has a length 30, a width 23 and height 22. The length 30 can be any operable length required to move the feed stream 25 from one point in the process to another, and to allow sufficient time to apply the hydrogen peroxide solution 16. The length 30 has a first end 27, a mid section 28, and a second end 29. The feed stream 25 enters the mix housing 4 at the first end 27 and exits the mix housing 4 at the second end 29.

The spray housing 1 is located adjacent to the mix housing 4. The spray housing 1 defines a spray chamber 2 and a spray chamber opening 3. The spray housing 1 is placed adjacent to the mix housing 4 such that the spray chamber opening 3 and the mix chamber opening 6 provides fluid communication between the spray chamber 2 and the mix chamber 5.

The spray housing 1 is located adjacent to the mix housing 4 such that the aqueous solution of hydrogen peroxide 16 is deposited onto the feed stream 25 to allow the feed stream 25 sufficient time to mix in the mix chamber 5. A spray nozzle 8 is coupled to the spray housing 1 and is fed by an air line 12 and a hydrogen peroxide line 17. Spray nozzle 8 sprays a mixture of air and hydrogen peroxide solution 16 through the spray chamber 2 and into the mix chamber 5 and gets deposited on the feed stream 25. Alternatively, spray nozzle 8 could spray the aqueous solution of hydrogen peroxide with out air. The aqueous solution of hydrogen peroxide 16 could also contain other feed additives, for example, propylene glycol or yucca extract.

The drawing illustrates just one of the many methods for adding the hydrogen peroxide to the feed. Other example methods of depositing the hydrogen peroxide 16 on the feed 25 are disclosed in U.S. patent application Ser. No. 10/440,432, filed May 16, 2003, which is hereby incorporated by reference in its entirety. It should be noted, however, that these are just examples of how the hydrogen peroxide could be applied to the feed to produce the desired results. There are many ways in which the hydrogen peroxide could be added to the feed to obtain the results of the present disclosure. For example, it could be batch mixed with an aqueous solution of hydrogen peroxide, or the feed could be treated multiple times depending on the feed and circumstances necessary to extend the shelf life.

There are also many different formulations of feed and hydrogen peroxide that can be used depending on the conditions in which the feed will be exposed. For example, larger weight percentages of hydrogen peroxide may be used where the feed is to be shipped greater distances and thus will be stored for a longer period of time prior to consumption by the livestock. In other circumstances, the weight percent of hydrogen peroxide may be lower where less time will elapse between production and consumption by the livestock. Thus, the weight percent of hydrogen peroxide could range from a very small amount, such as 0.05% for example, to a high percent, such as 75% or higher.

In one example embodiment, the amount of hydrogen peroxide to feed could be approximately 0.05 to 50.0 weight percent hydrogen peroxide to total weight of mixture. In another embodiment, the amount of hydrogen peroxide to feed could be approximately 1.50 to 20.0 weight percent hydrogen peroxide to total weight of mixture. In another example embodiment, the amount of hydrogen peroxide to feed could be approximately 2.50 to 6.0 weight percent hydrogen peroxide to total weight of mixture.

It is to be understood that even though numerous characteristics and advantages of various embodiments of the present disclosure have been set forth in the forgoing description, together with the details of this composition, this disclosure is illustrative only and changes may be made in detail especially in matters of formula and methods within the principles of the present disclosure, to the full extent indicated by the broad general meaning of the terms in which the appended claims are expressed.

1. A method for preparing feed that is resistant to mold and yeast contamination, comprising combining a feed with hydrogen peroxide.

2. The method as in claim 1, wherein the weight percent of the mixture is about 0.05% hydrogen peroxide to 50.0% hydrogen peroxide.

3. The method as in claim 1, wherein the weight percent of the mixture is about 1.50% hydrogen peroxide to 20.0% hydrogen peroxide.

4. The method as in claim 1, wherein the weight percent of the mixture is about 2.50% hydrogen peroxide to 6.0% hydrogen peroxide.

5. The method as in claim 1, wherein the feed contains a distillers' grain.

6. A method for preparing a feed that is resistant to mold and yeast contamination, comprising spraying an aqueous solution of hydrogen peroxide on feed.

7. The method as in claim 6, wherein the mixture of feed and the hydrogen peroxide are about uniformly mixed.

8. The method as in claim 6, wherein the feed contains a distillers' grain.

9. The method as in claim 6, wherein the aqueous solution of hydrogen peroxide contains a feed additive.

10. A method for preparing a feed, which is resistant to mold and yeast contamination comprising the steps of:
moving the feed under a sprayer;
spraying a mist of a solution containing hydrogen peroxide onto the feed;
mixing the feed and the solution containing hydrogen peroxide.

11. The method as in claim 10, wherein the feed contains a distillers' grain.

12. The method as in claim 10, wherein the mixture of feed and solution containing hydrogen peroxide is at least 0.05% hydrogen peroxide by weight.

13. The method as in claim 10, wherein the mixture of feed and solution containing hydrogen peroxide contains sufficient hydrogen peroxide to prevent visual detection of mold and yeast growth for at least 4 days.

14. The method as in claim 10, wherein the mixture of feed are mixed until the composition is approximately uniform.

15. A method of raising livestock comprising:
feeding livestock a diet consisting essentially of hydrogen peroxide-treated feed, the feed is substantially free of mold and yeast and resists mold and yeast contamination.

16. The method as in claim 15, wherein the peroxide-treated feed contains a distillers' grain.

17. A feed composition resistant to mold and yeast growth comprising:
hydrogen peroxide in the range of 0.05 to 20.0 weight percent hydrogen peroxide.

18. The feed composition as in claim 17, wherein a major component of the feed is a distillers' grain.

19. A feed composition resistant to mold and yeast growth comprising:
sufficient weight percent hydrogen peroxide such that the hydrogen peroxide extends the amount of time until mold and yeast can be visually detected.

20. The feed composition as in claim 19, wherein a major component of the feed is a distillers' grain.

21. A feed composition that resists mold and yeast growth comprising:
a distillers' grain; and
hydrogen peroxide.

22. The feed composition as in claim 21, wherein the amount of hydrogen peroxide is about from 0.05 to 10.0 weight percent hydrogen peroxide.

23. The feed composition as in claim 21, wherein the amount of hydrogen peroxide is sufficient to extend the amount of time until mold and yeast can be visually detected.
